(19) United States
(12) Patent Application Publication
(10) Pub. No.: US 2013/0313892 A1
(43) Pub. Date: Nov. 28, 2013

(54) POWER MANAGEMENT DEVICE AND METHOD

(71) Applicant: ACCTON TECHNOLOGY CORPORATION, Hsinchu (TW)

(72) Inventor: Hsien-Te CHANG, TAOYUAN (TW)

(73) Assignee: ACCTON TECHNOLOGY CORPORATION, HSINCHU (TW)

(21) Appl. No.: 13/803,443

(22) Filed: Mar. 14, 2013

(30) Foreign Application Priority Data
May 23, 2012 (TW) 101118377

(51) Int. Cl. G05F 3/08

(52) U.S. Cl. CPC G05F 3/08
USPC 307/4

(57) ABSTRACT

An apparatus and method for power management includes a first power supply module for obtaining power according to Power over Ethernet (PoE) technology and transmitting the power into a first power supply; a second power supply module providing a second power supply; a power detecting module outputting a first power voltage value corresponding to the first power supply; a power switching module receiving and outputting the first power supply, and outputting the second power supply when a switching signal is received; a mode determination module determining auto switching mode or manual switching mode and thereby generating an auto switching mode signal or manual switching mode signal; a control module transmitting a notification message when the first voltage value fails to meet a predetermined voltage during manual switching mode, and transmitting the switching signal when the first voltage fails to meet the predetermined voltage during auto switching mode.

The current application claims a foreign priority to the patent application of Taiwan No. 101118377 filed on May 23, 2012.

### BACKGROUND

1. Technical Field

The present invention relates to a method and a device for power management, particularly to power management device and method for a wireless access device.

2. Related Art

Through the popularization of handheld devices the need of the wireless Internet increases. Therefore, building wireless access points becomes an important task. With the mature Power over Ethernet (PoE) technology, the wireless access point which needs to be built outdoor or at elevated locations can obtain the electricity via the Ethernet cable, thereby increasing wireless access point location choices and decreasing the cost of electrical wiring.

However, once the power source for the wireless access point malfunctions, such as a power outage or unstable voltage, the wireless access point will stop working properly, which negatively influences the wireless Internet services for the terminal device. Therefore, the power management of the wireless access point becomes a very important issue.

Besides, all kinds of wireless access points are built in different places and have different functions (such as household access point, enterprise access point, or outdoor access point, etc.). No such device or method provides switching functions for the power management to adjust a suitable power management mode.

### BRIEF SUMMARY

The present invention provides a power management device, which includes a first power supply module obtaining power according to PoE technology and converting the obtained power into a first power supply; a second power supply module providing a second power supply; a power detecting module outputting a first voltage corresponding to the first power supply; a mode determination module used for determining an auto switching mode or a manual switching mode, and generating an auto switching mode signal or a manual switching mode signal when being set as the auto switching mode or the manual switching mode, respectively; a control module receiving the switching mode signal from the mode determination module and the first voltage from the power detecting module, and comparing the first voltage with a predetermined voltage in a predetermined comparing method when receiving the manual switching mode signal or the auto switching mode signal; when the first voltage does not meet the predetermined voltage, sending a warning signal in the manual switching mode or sending a switching signal in the auto switching mode; a power switching module receiving and outputting the first power supply, or receiving and outputting the second power supply according to the switching signal.

The present invention also provides a power management method used in a power management device which can communicate with a remote control center, and couples to a first power supply module for supplying power and a second power supply module for supplying back-up power. The power management module is set as an auto switching mode or a manual switching mode by a mode determination module. The power management method comprises generating a voltage relative to the power; comparing the voltage with a predetermined voltage; informing the remote control center when the voltage does not meet the predetermined voltage in the manual switching mode, and deciding whether to keep supplying the power by the first power supply module according to a signal sent by the remote control center; or switching to supply the power by the second power supply module when the power voltage does not meet the predetermined voltage in the auto switching mode.

The present invention further provides a power management method used in a power management device which can communicate with a remote control center, and couples to a first power supply module for supplying power and a second power supply module for supplying back-up power. The power management module is set as an auto switching mode or a manual switching mode by a mode determination module. The power management method comprises generating a voltage relative to the power; comparing the voltage with a predetermined voltage range; informing the remote control center with a warning signal when the power voltage value is not within the predetermined voltage range in the manual switching mode, and whether sending a switching signal according to a signal sent by the remote control center to switch the power supplied to the second power supply module, or not sending the switching signal to keep supplying the power by the first power supply module; and switching to supply the power by the second power supply module when the power voltage value is not within the predetermined voltage range in the auto switching mode.

The power management device and method according to the preferred embodiments of the present invention allow the wireless access device being able to switch the power management mode and switch the power supply when the power supply is abnormal. Therefore, the power management mode can be set flexibly according to the user's demand depending on the location of the wireless access device or the function which the wireless access device provides, thereby allowing the wireless access device to have the power supply switching function when the power supply is abnormal. In addition to the warning of an abnormal power supply, useful information of the abnormal condition can be provided to the monitoring staff for analyzing the power management.

### BRIEF DESCRIPTION OF THE DRAWINGS

These and other features and advantages of the various embodiments disclosed herein will be better understood with respect to the following description and drawings, in which like numbers refer to like parts throughout, and in which:

FIG. 1 is a schematic diagram of the wireless Internet access system according to an embodiment of the present invention; and

FIG. 2 is a flow chart of the power management method according to an embodiment of the present invention.

### DETAILED DESCRIPTION

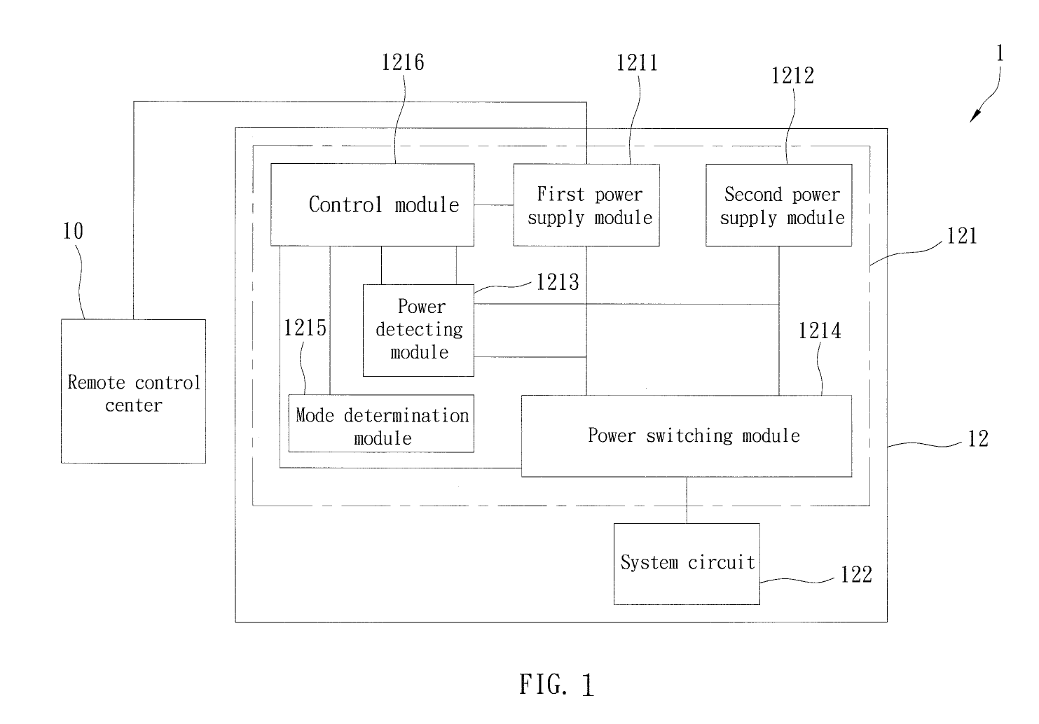

FIG. 1 is a schematic diagram of the wireless Internet access system according to an embodiment of the present invention. The wireless Internet access system 1 includes a remote control center 10 and a wireless access device 12. The wireless access device 12 is used to convert the wireless signal sent by the terminal device(not shown in the figure) to a wired signal and transmit the wired signal to the destined address, or further convert the wired signal back to the wireless signal and transmit the wireless signal to other destined addresses.

The wireless access device 12 can be a wireless access point, wireless router, or wireless gateway, etc. The terminal device can be a smart phone, a laptop, a tablet, a computer, or any wireless communication terminal device or the equivalent.

Besides, the wireless signal is the IEEE802.11 or Wi-Fi standard wireless communication packet signal, and the wired signal is the IEEE802.3 or Ethernet communication standard signal.

The remote control center 10 transmits the wired signal to or receives the wired signal from the wireless access device 12 via all kinds of networks. The remote control center 10, such as an Ethernet exchange, etc., is a packet forwarding equipment arranged at the Internet service provider (ISP) or an Internet data center of a company. The operator or administrator for maintaining the stable of network operation can obtain the warning signal sent by the wireless access device 12 via the packet forwarding equipment, and control the wireless access device 12 via the packet forwarding equipment as well.

The remote control center 10 can also provide power via the Ethernet to the wireless access device 12 according to the PoE technology.

Please refer to FIG. 1: The wireless access device 12 further includes a power management device 121 and a system circuit 122. The system circuit 122 is used to execute the relative function of the wireless access device 12 so as to provide the service function for the user terminal, and receives the power from the power management device 121 to execute the relative signal access function for wireless or wired signal.

The power management device 121 includes a first power supply module 1211, a second power supply module 1212, a power detecting module 1213, a power switching module 1214, a mode determination module 1215, and a control module 1216.

The first power supply module 1211 receives the power according to the PoE technology, and further converts the received power into a first power supply. The first power supply module 1211 is a power receiving module to receive the 48V direct current power provided by the power supply equipment (PSE) via the Ethernet according to the standard of Power over Ethernet, such as IEEE 802.3at/af, and the first power supply module 1211 can also receive and process the wired signal. In one embodiment of the present invention, the first power supply module 1211 can be a chipset or the equivalent being able to receive power from the Ethernet.

The second power supply module 1212 is used to provide a second power supply. The second power supply module 1212 is a battery which provides the power to the wireless access device 12. The second power supply module 1212 can also be a solar power supply module or an alternating current to direct current power supply module, or any kind of power supply module.

According to the first power supply and the second power supply, the power detecting module 1213 outputs a first voltage and a second voltage corresponding to the first power supply and the second power supply, respectively. The power detecting module 1213 is an analog-to-digital converter (ADC), which provides the first voltage and second voltage corresponding to the first power supply of the first power supply module 1211 and the second power supply of the second power supply module 1212, respectively.

The power switching module 1214 is used to receive and output the first power supply, and outputs the second power supply according to a switching signal. More specifically, the power switching module 1214 controls the power that the wireless access device 12 needs supplied from the first power supply of the first power supply module 1211 or supplied from the second power supply of the second power supply module 1212. The power switching module 1214 is a power switching chip, and the switching signal is a control signal used to control the power switching chip to change the power supply source.

The mode determination module 1215 is used to determine if the wireless access device 12 is in an auto switching mode or in a manual switching mode. The mode determination module 1215 generates an auto switching mode signal when in the auto switching mode, and generates a manual switching mode signal when in the manual switching mode.

The mode determination module 1215 is a user operating interface, which provides the user the option to set up the auto switching mode or the manual switching mode. When the user sets up the wireless access device 12 as the auto switching mode via the mode determination module 1215, the mode determination module 1215 can generate the auto switching mode signal; if the wireless access device 12 is set as the manual switching mode, the mode determination module 1215 can generate the manual switching mode signal.

In another embodiment of the present invention, the mode determination module 1215 is an ON/OFF switch element, such as a DIP switch. By setting up the ON/OFF state of the switch, the manual switching mode signal representing the manual switching mode and the auto switching mode signal representing the auto switching mode can be generated respectively.

The control module 1216 is used to send a warning signal when the first voltage fails to meet a predetermined voltage in the manual switching mode, and send the switching signal when the first voltage fails to meet a predetermined voltage in the auto switching mode.

The control module 1216 determines the power management mode as the manual switching mode or the auto switching mode according to the manual switching mode signal or the auto switching mode signal generated by the mode determination module 1215. The control module 1216 also receives the first voltage and the second voltage generated by the power detecting module 1213, thereby comparing the first voltage with the predetermined voltage.

When in the auto switching mode, if the first voltage fails to meet the predetermined voltage, the control module 1216 will generate and send the switching signal to the power switching module 1214 to switch the power supply from the first power supply to the second power supply.

When in the manual switching mode, if the first voltage fails to meet the predetermined voltage, the control module 1216 sends the warning signal to the remote control center 10 via the first power supply module 1211, and determines whether it is switched to supply the power from the second power module 1212 according to a first power controlling signal which is sent by the remote control center 10 and received by the first power supply module 1211.

If the second power supply module 1212 is determined by remote control center 10 to supply power to the wireless access device 12, the control module 1216 will send the switching signal according to the first power controlling signal sent by the remote control center 10. If the second power supply module 1212 is determined by the remote control center 10 not to supply power the wireless access device 12, the control module 1216 will not send the switching signal according to a second power controlling signal sent by the remote control center 10.

The control module 1216 can be a micro controller, a digital signal processor, a chipset or the equivalent having the aforementioned functions, but not limited thereto. Besides, the predetermined voltage can be a voltage value or a voltage range, which is predetermined by the user and stored in the control module 1216. However, in other embodiments of the present invention, the predetermined voltage can also be stored in a storage device of the power management device 121 or the system circuit 122. If the user desires the wireless access device 12 to switch from the first power supply to the second power supply as soon as the first power supply is unstable, the predetermined voltage can be set as a precise voltage value, or a small voltage range, thereby adjusting the sensitivity of sending the warning signal or the switching signal.

Furthermore, the warning signal, the first power controlling signal, or the second power controlling signal can be sent according to the Simple Network Management Protocol (SNMP). The remote control center 10 is informed that the first power supply of the wireless access device 12 is abnormal by the information carried with the warning signal, and the remote control center 10 sends the first power controlling signal or the second power controlling signal according to the information of the warning signal to control whether the power management device 121 switches to the second power supply or not.

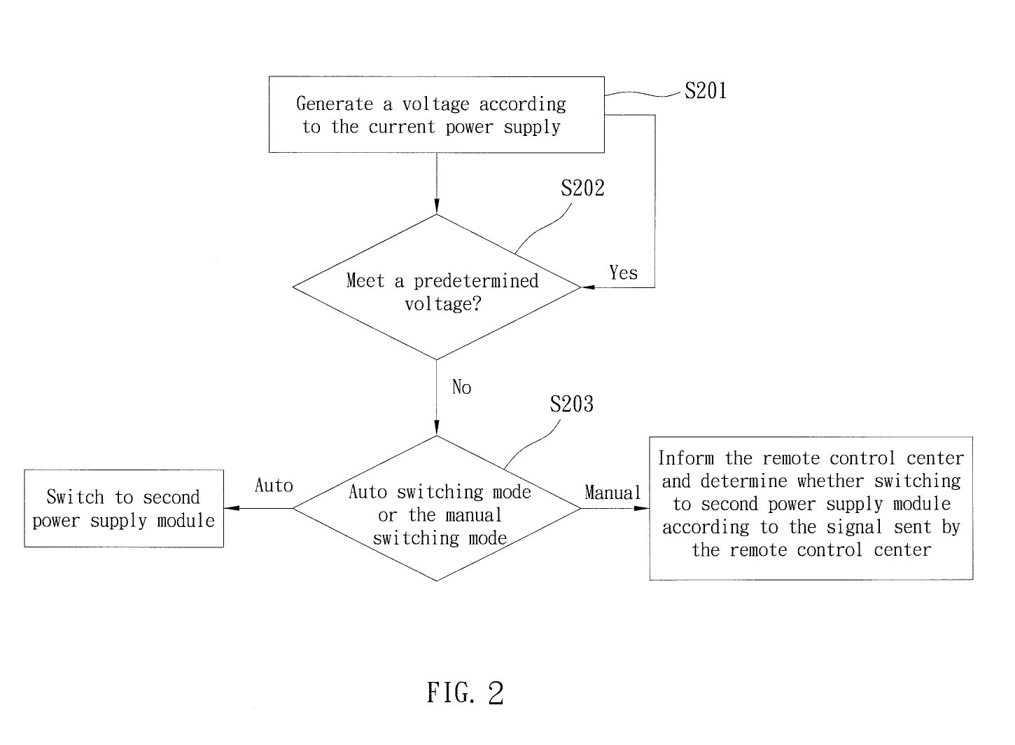

The FIG. 2 is a flow chart of the power management method according to an embodiment of the present invention. The FIG. 2 shows the power management method applied to the power management device 12 in FIG. 1 to provide the wireless access device 12 with the power management mode switching function, and the wireless access device 12 can flexibly set up the suitable power management mode according to the location or the desired function of the wireless access device 12.

Please refer to FIG. 1 and FIG. 2 together to understand the procedures of executing the power management method. It is noteworthy that the wireless access device 12 sets up the power management mode via the mode determination module 1215 which generates the auto switching mode signal representing the auto switching mode or the manual switching mode signal representing the manual switching mode. The detailed power management method according to the present invention is described as follows.

Step S201: Generating a corresponding voltage according to the current power. This step is used to obtain the power voltage inputted into the wireless access device 12. The first power supply module 1211 receives the power according to the PoE technology and converts the power into the first power supply for the wireless access device 12. According to the first power supply, the power detecting module 1213 provides the first voltage corresponding to the first power supply, and the control module 1216 detects the first voltage.

Step S202: Comparing the voltage of the current power supply with the predetermined voltage. If the voltage meets the predetermined voltage, back to step S201; if not, proceed to below-mentioned step S203. According to step S201, the voltage of the current power supply is the first voltage. This step is used to comparing the first voltage with the predetermined voltage. The predetermined voltage can be a voltage value, such as 48V; or the predetermined voltage can be a voltage range, such as 45V-50V, but not limited thereto. The predetermined voltage is preset by the user and stored in the control module 1216. However, in other embodiments, the predetermined voltage can be also stored in a storage device of the power management device 121 or the system circuit 122. In the preferred embodiment of the present invention, it is the control module 1216 which compares the first voltage with the predetermined voltage.

When the first voltage meets the predetermined voltage, back to step S201, and according to the first power supply, the power detecting module 1213 provides the first voltage corresponding to the first power supply, and the control module 1216 detects the first voltage.

When the first voltage does not meet the predetermined voltage, proceed to step S203. It is noteworthy that if the first voltage fails to meet the predetermined voltage either means the first voltage is not the same as a predetermined voltage value or the first voltage is not within a predetermined voltage range.

Step S203: Determining if the current control mode is the auto switching mode or the manual switching mode. In this step, when the control module 1216 obtains the manual switching signal from the mode determination module 1215, the first power supply module 1211 sends the warning signal to the remote control center 10 and waits for the power controlling signal sent by the remote control center 10 to decide whether the power of the wireless access device 12 is switched to be supplied by the second power supply module 1212.

When the first power supply module 1211 receives the power controlling signal sent by the remote control center 10, the control module 1216 obtains the power controlling signal and either sends the switching signal to switch the power supply of the wireless access device 12 to the second power supply 1212 or does not send the switching signal and keeps using the first power supply module to supply power to the wireless access device 12.

It is noteworthy that the power controlling signal can be the packet according to the SNMP, but not limited thereto. In the present embodiment, the warning signal is sent via the Ethernet cable of the first power supply module 1211 to the remote control center 10 by the Internet or local area network. By doing so, the remote control center 10 can be informed that the first power supply module 1211 is in an abnormal state.

The determination of the auto switching mode or manual switching mode is decided by the control module 1216 which generates the auto switching mode signal or the manual switching mode signal based on the ON/OFF state of the mode determination module 1215. In the present step, the control module 1216 obtains the auto switching mode signal sent by the mode determination module 1215 to further send the switching signal to instruct the second power supply module 1212 to supply the power of the wireless access device 12.

Based on the aforementioned embodiment of the present invention, the wireless access device 12 is equipped with the power management device 121 according to the embodiments of the present invention and has the function of switching the power management mode. The power management mode can flexibly be set as the auto switching mode or the manual switching mode by the user according to the location of the wireless access device 12 or the function it provides. For example, if the location of the wireless access device 12 cannot receive the signal sent by the remote control center 10, the power management mode can be set as the auto switching mode which allows the wireless access device 12 to automatically switch to the second power supply module 1212 and keep providing service when the first power supply module 1211 is abnormal. When the wireless access device 12 can be controlled by the remote control center 10, the power management mode can be set as the manual switching mode, and the monitoring staff can select the most suitable power source when the first power supply module 1211 is abnormal.

Moreover, the incorrect operation of power management for the wireless access device 12 can be avoided if the power supply is controlled based on the most suitable condition by the remote control center 10. And, by the warning signal sent from the wireless access device 12, the monitoring staff can record the time the abnormal condition happens, which can sufficiently help the monitoring staff to analyze the problems relative to the power management.

The invention being thus described, it will be obvious that the same functions may be achieved in various ways. Such variations are not to be regarded as a departure from the spirit and scope of the invention. All such modifications would be obvious to one skilled in the art and technology and are therefore intended to be included within the scope of the following claims.

What is claimed is:

1. A power management device, comprising:
a first power supply module obtaining power according to Power over Ethernet (PoE) technology and converting the obtained power into a first power supply;
a second power supply module providing a second power supply;
a power detecting module outputting a first voltage corresponding to the first power supply;
a mode determination module used for determining an auto switching mode or a manual switching mode, and generating an auto switching mode signal or a manual switching mode signal when being set as the auto switching mode or the manual switching mode, respectively;
a control module receiving the manual switching mode signal or the auto switching mode signal from the mode determination module, and the first voltage from the power detecting module, and comparing the first voltage with a predetermined voltage in a predetermined comparing method as the manual switching mode signal or the auto switching mode signal is received, when the first voltage does not meet the predetermined voltage, sending a warning signal in the manual switching mode or sending a switching signal in the auto switching mode; and
a power switching module receiving and outputting the first power supply, or receiving and outputting the second power supply according to the switching signal.

2. The power management device according to claim 1, wherein the control module sends the warning signal to a remote control center via the first power supply module.

3. The power management device according to claim 2, wherein the control module sends the switching signal after sending the warning signal according to a remote control signal sent by the remote control center.

4. The power management device according to claim 1, wherein the mode determination module further comprises an ON mode and an OFF mode, and the ON mode corresponding to the auto switching mode and the OFF mode corresponding to the manual switching mode.

5. The power management device according to claim 1, wherein the predetermined voltage has a voltage range.

6. A power management method used in a power management device which can communicate with a remote control center and couples to a first power supply module for supplying power and a second power supply module, wherein the power management module is set as an auto switching mode or a manual switching mode by a mode determination module, the power management method comprising:
generating a voltage relative to the power;
comparing the voltage with a predetermined voltage;
informing the remote control center when the power voltage does not meet the predetermined voltage in the manual switching mode, and deciding whether keep supplying the power by the first power supply module according to a signal sent by the remote control center; and switching to supply the power by the second power supply module when the power voltage does not meet the predetermined voltage in the auto switching mode.

7. The power management method according to claim 6, further comprising sending a warning signal to inform the remote control center.

8. The power management method according to claim 7, wherein the warning signal is sent via the first power supply module.

9. The power management method according to claim 6, wherein the remote control center either sends a switching signal to switch the power supplied from the first power supply module to the second power supply module, or the remote control center does not send the switching signal to keep supplying the power by the first power supply module.

10. The power management method according to claim 6, further comprising determining the manual switching mode or the auto switching mode by the mode determination module.

11. The power management method according to claim 7, wherein the predetermined voltage is a voltage range and the warning signal is sent to the remote control center when the voltage is not within the voltage range.

12. The power management method according to claim 11, wherein the warning signal is sent to the remote control center according to a simple network management protocol (SNMP).

13. A power management method used in a power management device which can communicate with a remote control center and couples to a first power supply module for supplying power and a second power supply module, wherein the power management module is set as an auto switching mode or a manual switching mode by a mode determination module, the power management method comprising:
generating a voltage relative to the power;
comparing the voltage with a predetermined voltage range;
informing the remote control center with a warning signal when the power voltage is not within the predetermined voltage range in the manual switching mode, and sending a switching signal according to a signal sent by the remote control center to switch the power supplied to the second power supply module, or not sending the switching signal to keep supplying the power by the first power supply module; and
switching to supply the power by the second power supply module when the power voltage is not within the predetermined voltage range in the auto switching mode.

14. The power management method according to claim 13, wherein the warning signal is sent via the first power supply module.

15. The power management method according to claim 13, further comprising determining the manual switching mode or the auto switching mode by the mode determination module.
